(19) United States
(12) Patent Application Publication
(10) Pub. No.: US 2010/0033475 A1
(43) Pub. Date: Feb. 11, 2010

(54) LIQUID CRYSTAL DISPLAY AND CONTROL METHOD THEREOF

(75) Inventors: Yong-Jun CHOI, Cheonan-si (KR); Bong-Im PARK, Cheonan-si (KR); Yun-Jae KIM, Asan-si (KR); Jae-Won JEONG, Seoul (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/410,831

(22) Filed: Mar. 25, 2009

(30) Foreign Application Priority Data
Aug. 6, 2008 (KR) 10-2008-0077037

(51) Int. Cl. G09G 5/00; G09G 3/36

(52) U.S. Cl. 345/214; 345/89

(57) ABSTRACT

A method of controlling a liquid crystal display includes comparing a pixel data signal from a previous frame with a pixel data signal from a present frame to generate a comparison result, controlling a driving voltage based on the comparison result, generating gray scale voltages, and adjusting voltage differences between the gray scale voltages based on the driving voltage. The controlling the driving voltage includes changing the driving voltage when the pixel data signal from the previous frame corresponds to a full-black gray scale level and the pixel data signal from the present frame corresponds to a full-white gray scale level.

This application claims priority to Korean Patent Application No. 2008-77037, filed on Aug. 6, 2008, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display and, more particularly, to a liquid crystal display having a substantially increased liquid crystal response speed, and a control method of the liquid crystal display.

2. Description of the Related Art

In general, a liquid crystal display (“LCD”) applies an electric field to a liquid crystal interposed between two substrates and having dielectric anisotropy. More particularly, a transmittance of light passing through the liquid crystal is controlled by adjusting an intensity of the electric field, thereby displaying a desired image on the LCD. A typical LCD is, for example, a thin film transistor LCD (“TFT-LCD”) having a thin film transistor for a switching operation. Alignment of the liquid crystal varies depending on a voltage applied to the thin film transistor, and light transmittance varies depending on the alignment of the liquid crystal to display the image.

A predetermined amount time is required before the liquid crystal is charged with a predetermined target voltage after the voltage is applied thereto. When a response speed of the liquid crystal, aligned according to the voltage applied thereto, is slow, a dynamic image is not properly displayed, due to an image dragging phenomenon. To increase the response speed of the liquid crystal, a dynamic capacitance compensation (“DCC”) method, which applies a gray scale voltage higher than a preset gray scale voltage to the liquid crystal, has been proposed.

However, even when the DCC method is used, when the final target voltage level is at a maximum allowable value, gray scale data higher than the final target voltage level cannot be applied to the liquid crystal. For example, in a data driver including an 8-bit digital-to-analog converter (“DAC”), compensation for a 28 (256)-gray scale cannot be performed because there is no gray scale higher than the 256-gray scale. Thus, the response speed of the liquid crystal does not increase.

Further, when a gray scale is changed from a full-black gray scale level to a full-white gray scale level, e.g. from a 0-gray scale to a 255-gray scale, the response speed of the liquid crystal does not increase.

### BRIEF SUMMARY OF THE INVENTION

Exemplary embodiments of the present invention provide a liquid crystal display having a substantially increased response speed.

Alternative exemplary embodiments of the present invention provide a method of controlling the liquid crystal display.

In an exemplary embodiment of the present invention, a method of controlling a liquid crystal display includes comparing a pixel data signal from a previous frame with a pixel data signal from a present frame to generate a comparison result. A driving voltage is controlled based on the comparison result. Gray scale voltages are generated, and a voltage differences between the gray scale voltages are adjusted based on the driving voltage.

In the controlling of the driving voltage, the driving voltage is changed when the pixel data signal from the previous frame corresponds to a full-black gray scale level and the pixel data signal from the present frame corresponds to a full-white gray scale level.

The controlling of the driving voltage further includes activating an overshoot signal when the pixel data signal from the previous frame corresponds to the full-black gray scale level and the pixel data signal from the present frame corresponds to the full-white gray scale level.

The adjusting the voltage differences between the gray scale voltages includes adjusting a level of a maximum gray scale voltage and a level of a minimum gray scale voltage, and adjusting a voltage difference between gray scale voltages less than the maximum gray scale voltage and greater than the minimum gray scale voltage.

The driving voltage includes a storage voltage.

An inversion signal is alternately activated and deactivated in consecutive frames, and the storage voltage is increased or decreased in response to the inversion signal when the overshoot signal is activated.

The driving voltage includes a driving supply voltage.

In an alternative exemplary embodiment of the present invention, a liquid crystal display includes a liquid crystal panel, a driving circuit, a timing controller, a voltage generating circuit and a gray scale voltage generating circuit. The liquid crystal panel includes data lines and gate lines. The driving circuit drives the data lines and the gate lines. The timing controller receives a pixel data signal from a previous frame, a pixel data signal from a present frame, a data enable signal and a clock signal to output control signals used to control the driving circuit, and compares the pixel data signal from the previous frame with the pixel data signal from a present frame to generate an overshoot signal based thereon. The voltage generating circuit generates a driving voltage based on the overshoot signal. The gray scale voltage generating circuit generates gray scale voltages and adjusts voltage differences between the gray scale voltages based on the overshoot signal.

The timing controller activates the overshoot signal when the pixel data signal from the previous frame corresponds to a full-black gray scale level and the pixel data signal from the present frame corresponds to a full-white gray scale level.

The driving voltage includes a driving supply voltage.

The gray scale voltage generating circuit includes a plurality of resistors, a resistor control circuit and a gray scale voltage generator. Resistors of the plurality of resistors being connected in electrical series with each other, the resistor control circuit includes a plurality of auxiliary resistors, and each auxiliary resistor of the plurality of auxiliary resistors configured to be connected in electrical parallel with a corresponding resistor of the plurality of resistors in response to the overshoot signal. The gray scale voltage generator which receives voltages from connection nodes between the resistors of the plurality of resistors to generate the gray scale voltages in response to the overshoot signal.

The gray scale voltage generator includes a look-up table having values used to adjust the voltage differences between the gray scale voltages in response to the overshoot signal.

The voltages from the connection nodes between the resistors include a maximum gray scale voltage and a minimum gray scale voltage, and the gray scale voltages generated by the gray scale voltage generator have values between the maximum gray scale voltage and the minimum gray scale voltage.

The voltage generating circuit includes a DC/DC converter, a first resistor, a switch and a second resistor. The DC/DC converter receives a supply voltage to output a first voltage to a first node. The first resistor is connected between the first node and a second node. The switch and the second resistor are connected in electrical series with each other between the first and second nodes and in electrical parallel with the first resistor. The switch operates in response to the overshoot signal, and a voltage of the second node includes the driving supply voltage.

The driving voltage includes a storage voltage.

The timing controller generates an inversion signal alternately activated and deactivated in consecutive frames, and the voltage generating circuit increases or decreases the storage voltage in response to the inversion signal when the overshoot signal is activated.

According to exemplary embodiments of the present invention, a response speed of the liquid crystal display is substantially increased. Specifically, when a gray scale is changed from a full-black gray scale level to a full-white gray scale level, e.g. from a 0-gray scale to a 255-gray scale, the response speed of liquid crystal is substantially increased.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of an exemplary embodiment of a liquid crystal display according to the present invention;

FIG. 2 is a table of response speeds for given frames illustrating variation in a response speed when gray scales of a (k-1)^{th} frame and a k^{th} frame are changed;

FIG. 3 is a graph of voltage versus frame number illustrating a variation in a data line driving voltage of the exemplary embodiment of a driving voltage generator of the liquid crystal display shown in FIG. 1;

FIG. 4 is a block diagram of an exemplary embodiment of a driving voltage generator of a liquid crystal display according to the present invention;

FIG. 5 is a block diagram of an exemplary embodiment of a gray scale voltage generating circuit of a liquid crystal display according to the present invention;

FIG. 6 is a look-up table of an exemplary embodiment of the gray scale voltage generator shown in FIG. 5;

FIG. 7 is a graph of voltage versus frame number illustrating a variation in a data line driving voltage of an alternative exemplary embodiment of a driving voltage generator according to the present invention;

FIG. 8 is a block diagram of another alternative exemplary embodiment of a voltage generating circuit according to the present invention;

FIGS. 9 and 10 are signal timing diagrams illustrating a variation in a storage voltage in an exemplary embodiment of a liquid crystal display according to the present invention; and

FIG. 11 is a flow chart illustrating an operation of an exemplary embodiment of a liquid crystal display according to the present invention.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

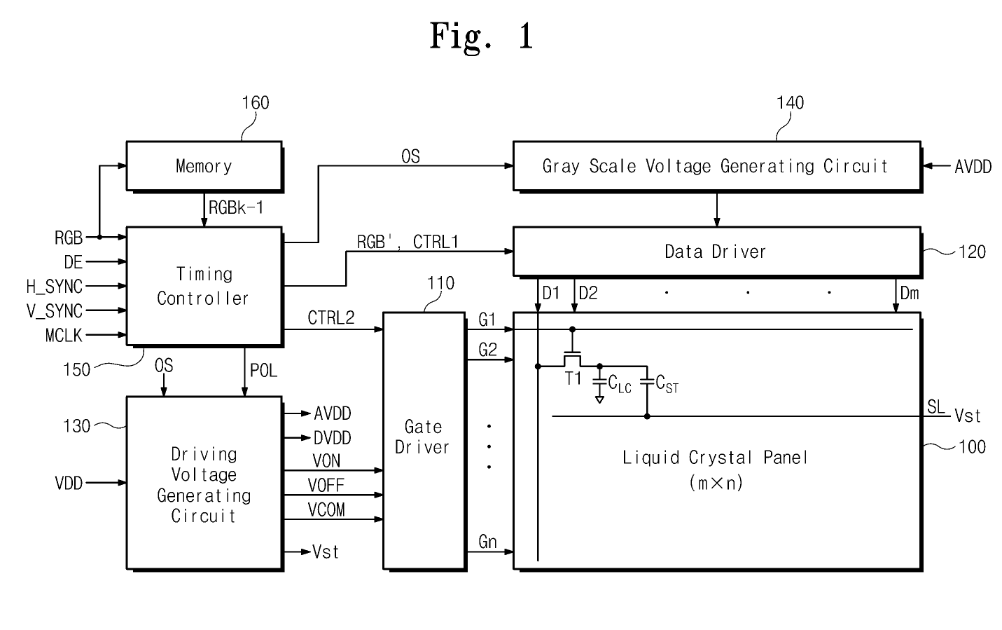

FIG. 1 is a block diagram of an exemplary embodiment of a liquid crystal display according to the present invention.

Referring to FIG. 1, the liquid crystal display includes a liquid crystal panel 100, a gate driver 110, a data driver 120, a driving voltage generating circuit 130, a gray scale voltage generating circuit 140, a timing controller 150 and a memory 160. The gate driver 110, the data driver 120, the driving voltage generating circuit 130, the gray scale voltage generating circuit 140 and the timing controller 150, collectively referred to as a driving apparatus, output a signal, displayed on the liquid crystal panel 100, by converting an image signal provided from an external device (not shown) such as a graphic controller, for example.

The liquid crystal panel 100 includes a plurality of gate lines G1 to Gn, a plurality of data lines D1 to Dm, and pixels. In an exemplary embodiment, the pixels are aligned in areas defined by gate lines G1 to Gn of the plurality of gate lines G1 to Gn and data lines D1 to Dm of the plurality of data lines D1 to Dm. Each pixel includes a thin film transistor T1 having a gate electrode and a source electrode, and a liquid crystal capacitor C_{LC} and a storage capacitor C_{ST} connected with a drain of the thin film transistor T1. In addition, the gate electrode of the thin film transistor T1 is connected to a corresponding gate line of the gate lines G1 to Gn and the source electrode of the thin film transistor T1 is connected to a corresponding data line of the data lines D1 to Dm. Thus, when the gate lines G1 to Gn are sequentially selected by the gate driver 110 and a pulse type gate-on voltage VON is applied to a selected gate line, the thin film transistor T1 of a corresponding pixel connected to the selected gate line is turned on and a voltage having pixel information is applied to each data line of the data lines D1 to Dm by the data driver 120. The voltage having the pixel information is applied to the liquid crystal capacitor C_{LC} and the storage capacitor C_{ST} via the thin film transistor T1 of the corresponding pixel, and the liquid crystal capacitor C_{LC} and the storage capacitor C_{ST} are thereby driven. Thus, an operation of displaying the image on the liquid crystal panel 100 is performed.

Since liquid crystal, disposed in the pixel, has dielectric anisotropy, a dielectric constant thereof varies based on an alignment direction of the liquid crystal. Specifically, when a voltage is applied to the liquid crystal, an alignment direction of the liquid crystal is changed, thereby changing the dielectric constant. Thus, a capacitance (hereinafter referred to as a liquid crystal capacitance) of the liquid crystal capacitor C_{LC} is changed. Electric charges are supplied to the liquid crystal capacitor C_{LC} for a turn-on interval of the thin film transistor T1, and the thin film transistor T1 is turned off. Thus, according to equation Q=CV, where Q is charge, C is capacitance and V is voltage, a pixel voltage applied to the liquid crystal is changed as the liquid crystal capacitance is changed.

The gate driver 110 sequentially applies the gate-on voltage VON to the gate lines G1 to Gn to turn on the thin film transistors T1 connected to each of the gate lines G1 to Gn. The data driver 120 drives the data lines D1 to Dm with a gray scale voltage corresponding to a pixel data signal RGB′ from the timing controller 150.

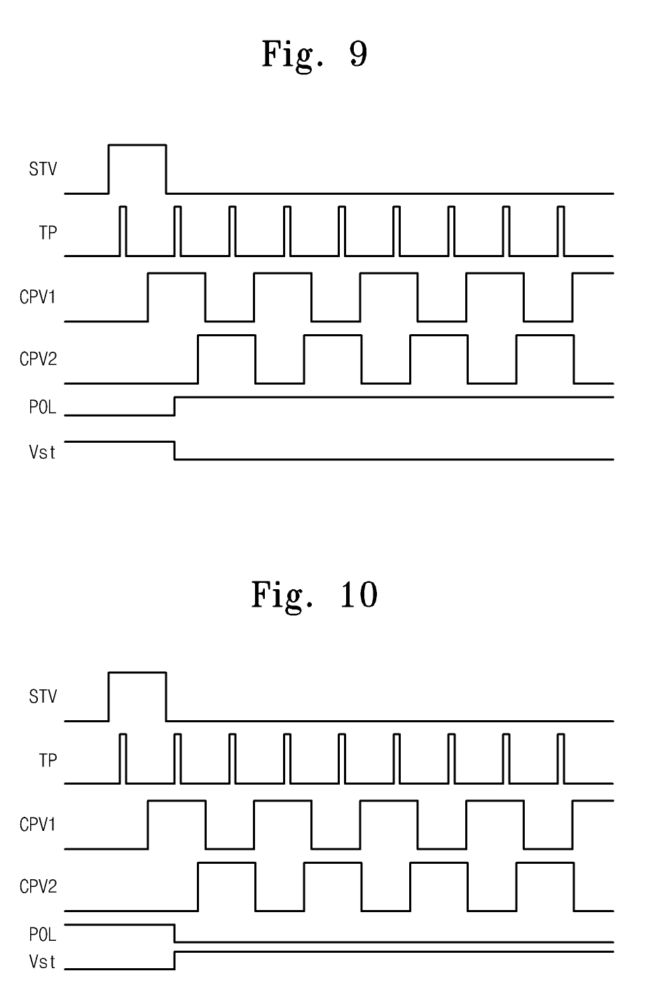

Still referring to FIG. 1, the memory 160 has a storage capacity which stores pixel data for at least one frame. The timing controller 150 receives a pixel data signal RGB, a data enable signal DE, horizontal and vertical synchronization signals H_sync and V_sync, respectively, and a clock signal MCLK. The timing controller 150 outputs a control signal CTRL1, used to control the data driver 120, the pixel data signal RGB′, a control signal CTRL2, used to control the gate driver 110, an overshoot signal OS, and a polarity inversion signal POL. The control signal CTRL1 includes a latch signal TP (FIGS. 9 and 10), a horizontal synchronization start signal, a clock signal and the polarity inversion signal POL. The control signal CTRL2 includes a vertical synchronization start signal, gate clock signals, and an output enable signal.

When gate driving ICs in the gate driver 110 cannot be mounted at one side of the liquid crystal panel 100, the timing controller 150 can provide two gate clock signals CPV1 and CPV2 to the gate driver 110 in a dual bank structure of disposing driving integrated circuits (“ICs”) disposed at sides of the liquid crystal panel 100, for example.

The timing controller 150 stores the pixel data signal RGB for a present frame input from an external device (not shown) to the memory 160, and selectively activates the overshoot signal OS based on a comparison of a pixel data signal RGBₖ₋₁ of a previous frame stored in the memory 160 with the pixel data signal RGB, e.g., RGBₖ, of the present frame.

In an exemplary embodiment, the driving voltage generating circuit 130 receives a supply voltage VDD and the polarity inversion signal POL and generates voltages, such as a common voltage VCOM, a storage voltage Vst, a driving supply voltage AVDD, a digital driving voltage DVDD, the gate-on voltage VON and a gate-off voltage VOFF, for operation of the liquid crystal display. In an exemplary embodiment, the driving voltage generating circuit 130 outputs the driving supply voltage AVDD at a level higher than a normal operational level of the driving supply voltage AVDD based on the overshoot signal OS. In addition, the gray scale voltage generating circuit 140 outputs a plurality of gray scale voltages by adjusting a voltage difference between gray scale voltages of the plurality of gray scale voltages based on the overshoot signal OS.

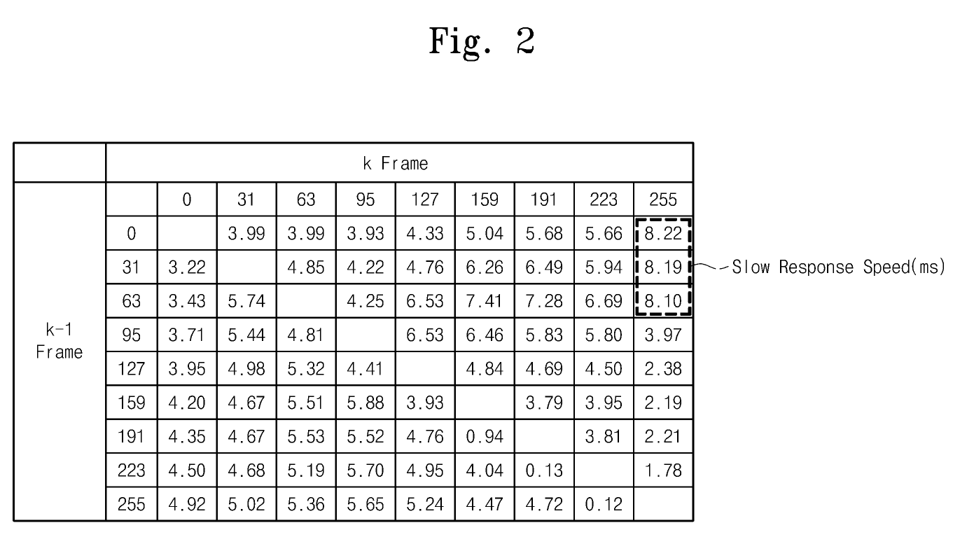

FIG. 2 is a table of response speeds for given frames illustrating a variation in a response speed when gray scales of a (k-1)^{th} frame, e.g., a previous frame, and an k^{th} frame, e.g., a present frame, are changed.

Referring to FIG. 2, when the previous frame, e.g., the (k-1)^{th} frame, is a 0-gray scale corresponding to a full-black, and the present frame, e.g., the k^{th} frame, is a 255-gray scale corresponding to a full-white, a response speed of the liquid crystal display is the slowest. Thus, to increase the response speed when a color tone is changed from the full-black gray scale to the full-white gray scale, a data line driving voltage VD is generated at a level higher than the normal level. Hereinafter, a configuration and operation to substantially increase the response speed when the color tone is changed from the full-black to the full-white will be described in further detail. It will be noted, however, that exemplary embodiments of the present invention can be applied for changing a color tone is from a black (e.g., a 1-gray scale to a 63-gray scale) near the full-black to a white near the full-white, and that alternative exemplary embodiments are not limited thereto.

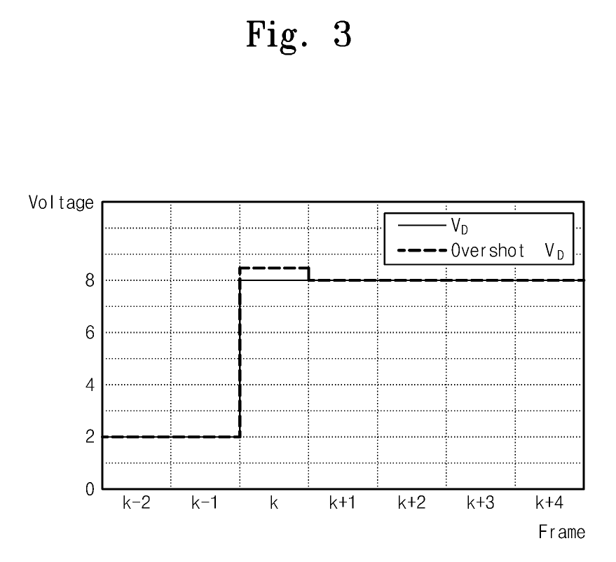

FIG. 3 is a graph of voltage versus frame number illustrating a variation in a data line driving voltage of the exemplary embodiment of a driving voltage generator of the liquid crystal display shown in FIG. 1.

When the pixel data signal RGBₖ₋₁ of the previous frame, stored in the memory 160, is the full-black (corresponding to the 0-gray scale) and the pixel data signal RGB of the present frame is the full-white (corresponding to the 255-gray scale), the timing controller 150 activates the overshoot signal OS to a high level. As a result, the driving voltage generating circuit 130 generates the driving supply voltage AVDD having a level higher than the normal level for one frame in response to the activated overshoot signal OS, as shown in FIG. 3. When the driving supply voltage AVDD is increased as described above, the gray scale voltage corresponding to the full-white of the driving supply voltage AVDD increases, thereby causing an increase in the data line driving voltage VD. Thus, the response speed is substantially increased when the color tone is changed from the full-black to the full-white. In an exemplary embodiment, the increased driving supply voltage AVDD is maintained for one frame, but alternative exemplary embodiments are not limited thereto.

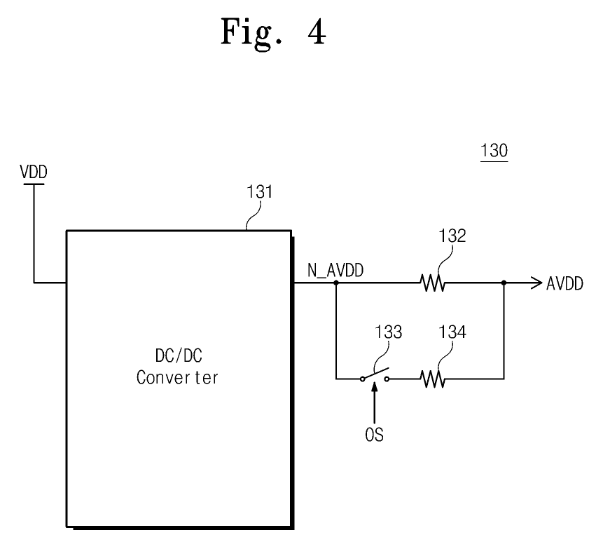

FIG. 4 is a block diagram of an exemplary embodiment of a driving voltage generator of a liquid crystal display according to the present invention.

Referring to FIG. 4, the driving voltage generating circuit 130 includes a DC/DC converter 131, resistors 132 and 134 and a switch 133. The DC/DC converter 131 receives the supply voltage VDD and outputs a voltage N_AVDD. The resistor 132 is connected between an output terminal of the voltage N_AVDD and an output terminal of the driving supply voltage AVDD, as shown in FIG. 4. The switch 133 and the resistor 134 are connected to opposite terminals of the resistor 132. The switch 133 is controlled by the overshoot signal OS.

More specifically, for a normal operation, the overshoot signal OS is at a low level and the switch 133 is in an off state. As a result, only the resistor 132 is connected between the output terminal of the voltage N_AVDD and the output terminal of the driving supply voltage AVDD. When the overshoot signal OS becomes a high level, however, the switch 133 is turned on and the resistors 132 and 134 are connected in parallel to each other and between the output terminal of the voltage N_AVDD and the output terminal of the driving supply voltage AVDD. Thus, the driving supply voltage AVDD supplied to the gray scale voltage generating circuit 140 (FIG. 1) increases based on a resistance value of the resistor 134.

In an exemplary embodiment, the DC/DC converter 131 generates various voltages (e.g. the gate-on voltage VON, the gate-off voltage VOFF and the common voltage VCOM) for operation of the liquid crystal display, as well as the voltage N_AVDD.

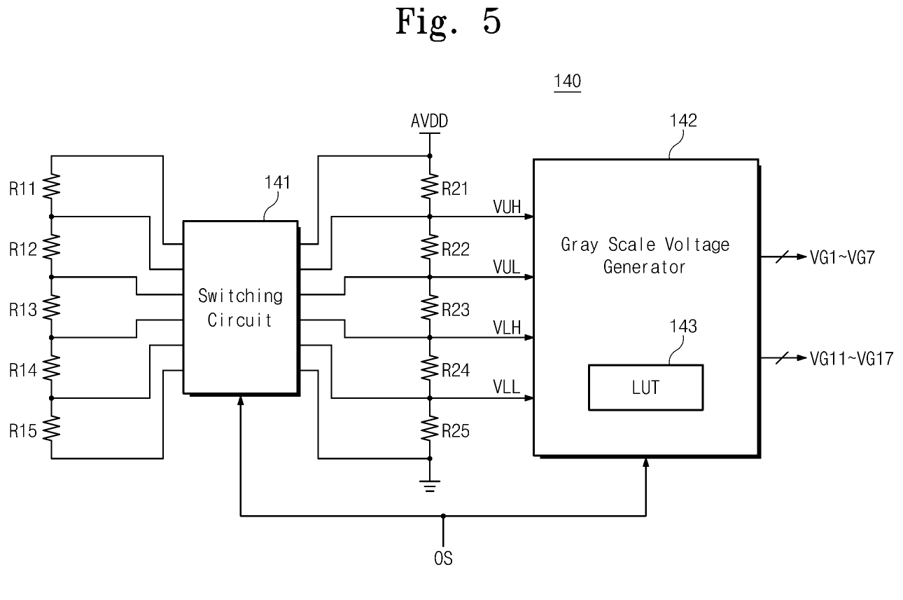

FIG. 5 is a block diagram of an exemplary embodiment of a gray scale voltage generating circuit of a liquid crystal display according to the present invention.

Referring to FIG. 5, the gray scale voltage generating circuit 140 includes resistors R11 to R15 and R21 to R25, a switching circuit 141 and a gray scale voltage generator 142. The resistors R11 to R15 are connected in electrical series with each other, as shown in FIG. 5. The resistors R21 to R25 are connected in electrical series with each other and between the driving supply voltage AVDD and a ground voltage. The resistors R11 to R15 correspond to the resistors R21 to R25, respectively.

The switching circuit 141 allows the resistors R11 to R15 to be connected in electrical parallel with the resistors R21 to R25 in response to the overshoot signal OS. For example, when the overshoot signal OS is at a high level, the resistor R21 is connected in parallel with the resistor R11 and the resistor R25 is connected in parallel with the resistor R15.

To prevent degradation of the liquid crystal, the liquid crystal display according to an exemplary embodiment alternately applies positive data line driving signals and negative data line driving signals to a common electrode Vcom (referred to as an inverse driving scheme). Specifically, the gray scale voltage generator 142 generates gray scale voltages VG1 to VG7, higher than the common voltage VCOM, and gray scale voltages VG11 to VG17 lower than the common voltage VCOM. Voltages VUH, VUL, VLH and VLL at corresponding nodes between the resistors R21 to R25 correspond to maximum and minimum gray scale voltages of the positive gray scale voltages VG1 to VG7, and maximum and minimum gray scale voltages of the negative gray scale voltages VG11 to VG17, respectively.

More specifically, the gray scale voltage generator 142 generates the positive gray scale voltages VG1 to VG7 between the maximum and minimum gray scale voltages VUH and VUL, and the negative gray scale voltages VG11 to VG17 between the maximum and minimum gray scale voltages VLH and VLL.

When the overshoot signal OS is at the high level, the driving supply voltage AVDD increases, as described above, thereby causing variations in levels of the positive maximum and minimum gray scale voltages VUH and VUL, respectively, and levels of the negative maximum and minimum gray scale voltages VLH and VLL, respectively. Thus, the resistors R11 to R15 are connected in parallel with opposite respective ends of the resistors R21 to R25, and levels of the positive maximum and minimum gray scale voltages VUH and VUL, respectively, are thereby adjusted as well as the levels of the negative maximum and minimum gray scale voltages VLH and VLL, respectively. For example, when the level of the positive maximum gray scale voltage VUH increases, the level of the negative minimum gray scale voltage VLL decreases, and the levels of the positive minimum gray scale voltage VUL and the negative maximum gray scale voltage VLH are not changed.

Consequently, the gray scale voltage generator 142 can generate the positive gray scale voltages VG1 to VG7 which increase by the positive maximum gray scale voltage VUH (increased when the overshoot signal OS is activated), and the negative gray scale voltages VG11 to VG17 which decrease by the negative minimum gray scale voltage VLL (reduced when the overshoot signal OS is activated).

When the pixel data signal RGB′ corresponds to the full-black in the previous frame and the full-white in the present frame, the overshoot signal OS is activated and the driving supply voltage AVDD thereby has a level higher than the normal level. As a result, a response speed of a pixel corresponding to the pixel data signal RGB′ changed to the full-white from the full-black is substantially increased. However, undesired high gray scale voltage may be applied to pixels that display a pixel data signal corresponding to intermediate gray scale voltage due to the increase in the driving supply voltage AVDD. Thus, the gray scale voltage generator 142 generates the gray scale voltages VG1 to VG7 and VG11 to VG17 with reference to a look-up table (“LUT”) 143 such that only gray scale voltages corresponding to a high gray scale are increased, while gray scale voltages corresponding to a low gray scale are not affected by the increase in the driving supply voltage AVDD when the overshoot signal OS is activated.

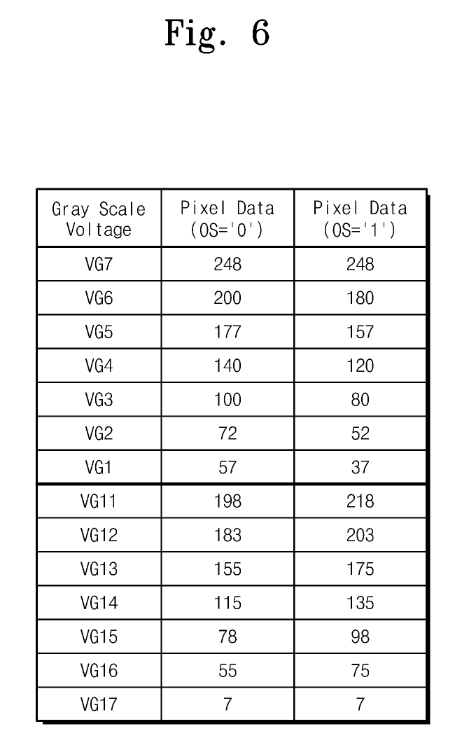

FIG. 6 is the look-up table of an exemplary embodiment of a gray scale voltage generator shown in FIG. 5.

Referring to FIG. 6, the gray scale voltage generator 142 generates the gray scale voltages using dynamic capacitance compensation (“DCC”) method to apply a voltage higher than a predetermined gray scale voltage to the liquid crystal. In an exemplary embodiment, the pixel data signal RGB′ displays the 0-gray scale to the 255-gray scale. For example, when the overshoot signal OS is at the low level, the positive gray scale voltages VG1 to VG7 correspond to gray scales 57, 72, 100, 140, 177, 200 and 248, respectively, and the negative gray scale voltages VG11 to VG17 correspond to gray scales 198, 183, 155, 115, 78, 55 and 7, respectively, as shown in FIG. 6. When the overshoot signal OS is at the high level, however, the positive gray scale voltages VG1 to VG7 correspond to gray scales from 37, 52, 80, 120, 157, 180 and 248, respectively, and the negative gray scale voltages VG11 to VG17 correspond to gray scales 218, 203, 175, 135, 98, 75 and 7, respectively. Thus, a gray scale difference between the positive gray scale voltages VG6 and VG7, for example, corresponding to the high gray scale is 68 when the overshoot signal OS is at the high level, which is larger than a gray scale difference (e.g., 48) occurring when the overshoot signal OS is at the low level. Similarly, a gray scale difference of the negative gray scale voltages VG16 and VG17, for example, correspond to the high gray scale 68, also larger than a gray scale difference (e.g., 48) occurring when the overshoot signal OS is at the low level. In addition, when the overshoot signal OS is at the high level, the gray scale voltage VG7 corresponds to the 248-gray scale, which is the same as when the overshoot signal OS is at the low level. However, since the driving supply voltage AVDD increases when the overshoot signal OS is at the high level, a voltage applied to the liquid crystal is relatively high, as compared to a case in which the overshoot signal OS is at the low level. As shown in FIG. 6, a gray scale difference occurring between each of the remaining gray scale voltages VG1 to VG6 and VG11 to VG16 when the overshoot signal OS is at the high level is identical to the gray scale difference occurring when the overshoot signal OS is at the low level.

As a result, when the gray scale is changed from the full-black gray scale to the full-white gray scale, the driving supply voltage AVDD increases, and the response speed of the liquid crystal is substantially increased, and an abnormal operation of the liquid crystal display according to an exemplary embodiment is effectively prevented when an intermediate gray scale is changed. In addition, to the change from the 0-gray scale to the 256-gray scale, as shown in FIG. 2, alternative exemplary embodiments are also applicable when the gray scale variation is great, such as change from the 31-gray scale of the previous frame to the 255-gray scale of the present frame.

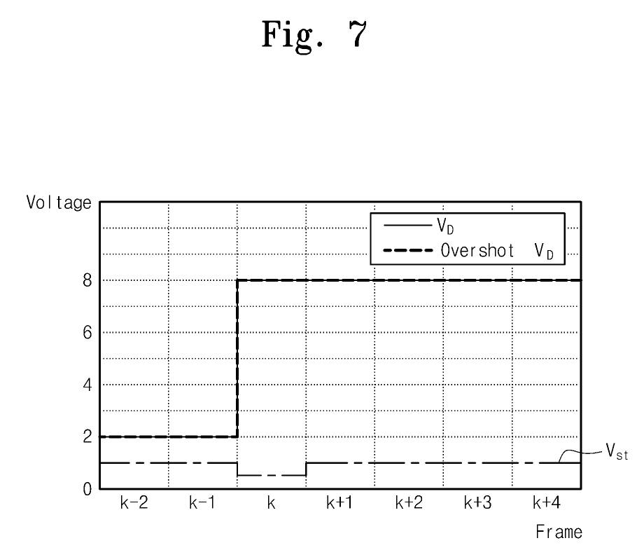

FIG. 7 is a graph of voltage versus frame number illustrating a variation in a data line driving voltage of an alternative exemplary embodiment of the present invention.

Referring to FIG. 7, when the overshoot signal is activated, the liquid crystal display increases a voltage difference between the gray scale voltage V_{D} applied to the data line and the storage voltage Vₛₜ by adjusting the storage voltage Vₛₜ. As a result, an effect substantially the same as described above, e.g., the overshoot driving of the driving supply voltage AVDD, as described with reference to FIG. 3, is obtained in the liquid crystal display according to an exemplary embodiment.

Referring again to FIG. 1, a liquid crystal cell is equivalently expressed as the liquid crystal capacitor C_{LC}, including a common electrode of the pixel electrode connected to the thin film transistor T1, while interposing the liquid crystal therebetween. Further, the liquid crystal cell includes the storage capacitor C_{ST} which stores the data voltage charged into the liquid crystal capacitor C_{LC} until a subsequent data voltage is charged therein. The storage voltage Vₛₜ generated from the driving voltage generating circuit 130 is applied to a terminal of the storage capacitor C_{ST}.

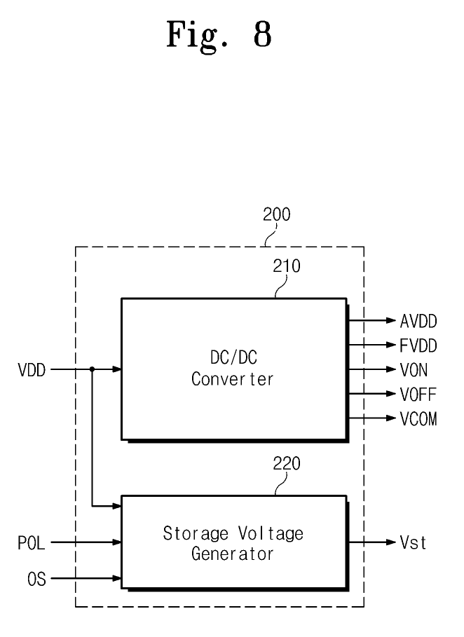

FIG. 8 is a block diagram of another alternative exemplary embodiment of a voltage generating circuit according to the present invention.

Referring to FIG. 8, a voltage generating circuit 200 according to an exemplary embodiment includes a DC/DC converter 210 and a storage voltage generator 220. The DC/DC converter 210 receives the supply voltage VDD and generates voltages such as the driving supply voltage AVDD, digital driving supply voltage FVDD, the gate on voltage VON, the gate off voltage VOFF and the common voltage VCOM for operation of the liquid crystal display. The storage voltage generator 220 receives a polarity inversion signal POL and the overshoot signal OS from the timing controller 150 and the supply voltage VDD to generate the storage voltage Vₛₜ.

FIGS. 9 and 10 are signal timing diagrams illustrating a variation in a storage voltage in an exemplary embodiment of a liquid crystal display according to the present invention.

As described above, the liquid crystal display according to an exemplary embodiment is driven using an inverse driving scheme, in which positive data signals and negative data signals, relative to the common voltage VCOM, are alternately applied to data lines, thereby effectively preventing a degradation of the liquid crystal. More particularly, the storage voltage Vₛₜ increases or decreases in synchronization with the inversion driving of the data lines to enable overshoot driving of the data signals applied to the data lines.

In an exemplary embodiment, the storage voltage Vₛₜ increases or decreases in response to the polarity inversion signal POL applied to the data driver 120.

As illustrated in FIG. 9, when the polarity inversion signal POL is at a high level, the data lines are driven by the gray scale voltages GV1 to GV7 having levels higher than levels of the common voltage VCOM. Thus, the storage voltage Vₛₜ decreases by a predetermined level. Thus, the voltage difference between the gray scale voltages GV1 to GV7 applied to the data lines and the storage voltage Vₛₜ is increased.

As illustrated in FIG. 10, when the polarity inversion signal POL is at a low level, the data lines are driven by the gray scale voltages GV11 to GV17 having levels lower than levels of the common voltage VCOM As a result, the storage voltage Vₛₜ increases by a predetermined level. Thus, the voltage difference between the gray scale voltages GV1 to GV7 applied to the data lines and the storage voltage Vₛₜ is increased.

Therefore, when the gray scale is changed from the full-black gray scale to the full-white gray scale, e.g., from the 0-gray scale to the 255-gray scale, a response speed of the liquid crystal is substantially increased.

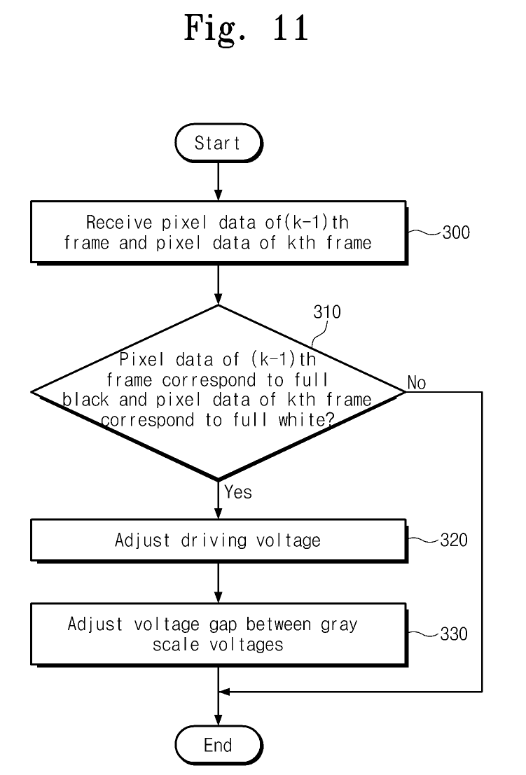

FIG. 11 is a flow chart illustrating an operation of an exemplary embodiment of a liquid crystal display according to the present invention.

Referring to FIG. 11, the timing controller 150 receives pixel data of a present frame from an external device (not shown), as well as pixel data of a previous frame. More specifically, the timing controller 150 receives pixel data of the (k-1)^{th} frame from the memory 160 and pixel data of the k^{th} frame from the external device (300).

When the pixel data of the (k-1)^{th} frame corresponds to the full-black and the pixel data of the k^{th} frame corresponds to the full-white (310), the timing controller 150 controls the driving voltage generating circuit 130 to adjust the driving voltage (320). The driving voltage includes at least one of the driving supply voltage AVDD and the storage voltage Vₛₜ.

The gray scale voltage generating circuit 140 adjusts a voltage difference between the gray scale voltages, under the control of the timing controller 150, when the driving voltage is controlled (330).

According to exemplary embodiments of the present invention as described herein, a response speed of a liquid crystal display is substantially increased. Specifically, when a gray scale is changed from a full-black gray scale level to a full-white gray scale level, e.g. from a 0-gray scale to a 255-gray scale, the response speed of liquid crystal is substantially increased.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A method of controlling a liquid crystal display, the method comprising:
comparing a pixel data signal from a previous frame with a pixel data signal from a present frame to generate a comparison result;
controlling a driving voltage based on the comparison result;
generating gray scale voltages; and
adjusting voltage differences between the gray scale voltages based on the driving voltage.

2. The method of claim 1, wherein the controlling the driving voltage comprises changing the driving voltage when the pixel data signal from the previous frame corresponds to a full-black gray scale level and the pixel data signal from the present frame corresponds to a full-white gray scale level.

3. The method of claim 1, wherein the controlling the driving voltage further comprises activating an overshoot signal when the pixel data signal from the previous frame corresponds to the full-black gray scale level and the pixel data signal from the present frame corresponds to the full-white gray scale level.

4. The method of claim 3, wherein the adjusting the voltage differences between the gray scale voltages comprises:
adjusting a level of a maximum gray scale voltage and a level of a minimum gray scale voltage; and
adjusting a voltage difference between gray scale voltages less than the maximum gray scale voltage and greater than the minimum gray scale voltage.

5. The method of claim 4, wherein the driving voltage comprises a storage voltage.

6. The method of claim 5, further comprising generating an inversion signal, wherein
the inversion signal is alternately activated and deactivated in consecutive frames, and
the storage voltage is increased or decreased, based on the inversion signal, when the overshoot signal is activated.

7. The method of claim 1, wherein the driving voltage comprises a driving supply voltage.

8. A liquid crystal display comprising:
a liquid crystal panel comprising data lines and gate lines;
a driving circuit which drives the data lines and the gate lines;
a timing controller which receives a pixel data signal from a previous frame, a pixel data signal from a present frame, a data enable signal and a clock signal, and which compares the pixel data signal from the previous frame with the pixel data signal from the present frame to generate an overshoot signal based thereon;
a voltage generating circuit which generates a driving voltage based on the overshoot signal; and
a gray scale voltage generating circuit which generates gray scale voltages and adjusts voltage differences between the gray scale voltages based on the overshoot signal.

9. The liquid crystal display of claim 8, wherein the timing controller activates the overshoot signal when the pixel data signal from the previous frame corresponds to a full-black gray scale level and the pixel data signal from the present frame corresponds to a full-white gray scale level.

10. The liquid crystal display of claim 8, wherein the driving voltage comprises a driving supply voltage.

11. The liquid crystal display of claim 10, wherein the gray scale voltage generating circuit comprises:
a plurality of resistors connected between the driving supply voltage and a ground voltage, resistors of the plurality of resistors being connected in electrical series with each other;
a resistor control circuit comprising a plurality of auxiliary resistors, each auxiliary resistor of the plurality of auxiliary resistors configured to be connected in electrical parallel with a corresponding resistor of the plurality of resistors in response to the overshoot signal; and
a gray scale voltage generator which receives voltages from connection nodes between the resistors of the plurality of resistors to generate the gray scale voltages in response to the overshoot signal.

12. The liquid crystal display of claim 11, wherein the gray scale voltage generator comprises a look-up table having values used to adjust the voltage differences between the gray scale voltages in response to the overshoot signal.

13. The liquid crystal display of claim 11, wherein
the voltages from the connection nodes between the resistors comprise a maximum gray scale voltage and a minimum gray scale voltage, and
the gray scale voltages generated by the gray scale voltage generator have values between the maximum gray scale voltage and the minimum gray scale voltage.

14. The liquid crystal display of claim 10, wherein the voltage generating circuit comprises:
a DC/DC converter which receives a supply voltage and outputs a first voltage to a first node;
a first resistor connected between the first node and a second node;
a switch connected to the first node; and
a second resistor connected between the switch and the second node, wherein the switch and the second resistor are connected in electrical parallel with the first resistor while being connected in electrical serial with each other between the first node and the second node,
the switch operates in response to the overshoot signal, and
a voltage of the second node comprises the driving supply voltage.

15. The liquid crystal display of claim 8, wherein the driving voltage comprises a storage voltage.

16. The liquid crystal display of claim 15, wherein
the timing controller generates an inversion signal,
the inversion signal is alternately activated and deactivated in consecutive frames, and
the voltage generating circuit increases or decreases the storage voltage in response to the inversion signal when the overshoot signal is activated.
